(19) United States
(12) Patent Application Publication
(10) Pub. No.: US 2026/0355957 A1
(43) Pub. Date: Nov. 12, 2026

(54) CONTROL APPARATUS AND PROGRAM

(71) Applicant: FANUC CORPORATION, Yamanashi (JP)

(72) Inventor: Weijun LI, Yamanashi (JP)

(21) Appl. No.: 19/139,856

(22) PCT Filed: Jan. 11, 2023
(86) PCT No.: PCT/JP2023/000440

§ 371 Date: Jun. 16, 2025

(51) Int. Cl. B25J 9/16

(52) U.S. Cl. CPC B25J 9/1664; B25J 9/163; B25J 9/1697

(57) ABSTRACT

A control apparatus according to the present disclosure includes a storage unit for storing data relating to a plurality of holding patterns for holding a workpiece with an end effector of a robot, a selection unit for selecting one holding pattern of the plurality of holding patterns for the workpiece, a control unit for controlling the robot based on the selected one holding pattern, a creation unit for creating a plurality of holding pattern candidates based on the holding pattern, a reception unit for receiving a user instruction for adding at least one of the created holding pattern candidates as the holding pattern, and a storage control unit for causing the storage unit to store the received holding pattern candidate as the holding pattern.

### RELATED APPLICATIONS

The present application is a National Phase of International Application No. PCT/JP2023/000440 filed Jan. 11, 2023.

### TECHNICAL FIELD

The present invention relates to a control apparatus and a program.

### BACKGROUND ART

There is known a technique for bulk picking in which a robot takes out a plurality of so-called bulk workpieces, which are placed at irregular intervals and in irregular orientations in a container or the like (for example, see Patent Literature 1). For example, in bulk picking, candidate positions for grasping a workpiece with a hand mounted on the robot are taught and set to the robot in advance.

### Citation List

### Patent Literature

Patent Literature 1: Japanese Unexamined Patent Application Publication No. 2019-028775

### SUMMARY

### Problem to be Solved

Since the robot can take out a workpiece only at the set holding positions, the robot may not be able to take out a workpiece from the container due to the interference of the hand mounted on the robot with the container or a workpiece. In order to deal with such a case, the user looks at the position and orientation of a workpiece that could not be held by the hand and are left within the container, and teaches a grasping position where the workpiece is likely to be taken out by the hand. Teaching the grasping position is a burdensome task for a user who is unfamiliar with setting for bulk picking, because the user needs to use an operation device such as a pendant while thinking about what holding position to teach so that the workpiece can be taken out by the hand. Therefore, it is desired to propose a technique for reducing the time and effort for teaching the holding position in bulk picking.

### Solution to Problem

In order to control a robot to execute an operation of taking out a bulk workpiece, a control apparatus according to the present disclosure includes: a storage unit for storing data relating to a plurality of holding patterns for holding the workpiece with an end effector of the robot, a selection unit for selecting one holding pattern of the plurality of holding patterns for the workpiece, a control unit for controlling the robot based on the selected one holding pattern, a creation unit for creating a plurality of holding pattern candidates based on the holding pattern, a reception unit for receiving a user instruction for adding at least one of the created holding pattern candidates as the holding pattern, and a storage control unit for causing the storage unit to store the received holding pattern candidate as the holding pattern.

### BRIEF DESCRIPTION OF THE DRAWINGS

FIG. 1 shows a robot system including a control apparatus according to a first embodiment.

FIG. 2 is a hardware configuration diagram of the control apparatus shown in FIG. 1.

FIG. 3 is a functional block diagram of the control apparatus shown in FIG. 1.

FIG. 4 shows an example of a holding pattern management table stored in a storage unit shown in FIG. 3.

FIG. 5 is a supplementary diagram for explaining a holding pattern shown in FIG. 4.

FIG. 6 is a supplementary diagram for explaining the process of creating holding pattern candidates shown in FIG. 4.

FIG. 7 shows an example of a reception screen created by a screen creation unit shown in FIG. 3.

FIG. 8 is a flowchart showing an example of the procedure of the operation of taking out a workpiece by the control apparatus according to the first embodiment.

FIG. 9 is a flowchart showing an example of the procedure of step S22 of FIG. 8.

FIG. 10 shows an example of an updated reception screen after clicking of a create button shown FIG. 7.

FIG. 11 shows an example of an updated reception screen after clicking of an add button shown in FIG. 10.

FIG. 12 shows another example of the updated reception screen after clicking of the create button shown in FIG. 7.

FIG. 13 shows an example of an updated reception screen after clicking of an execute button shown in FIG. 11.

FIG. 14 is a functional block diagram of a control apparatus according to a second embodiment.

FIG. 15 shows an example of a reception screen presented to the user by the control apparatus according to the second embodiment.

FIG. 16 shows the reception screen when a cursor is positioned on interference information in FIG. 15.

FIG. 17 shows the reception screen when an adjust button is clicked in FIG. 15.

### DETAILED DESCRIPTION

Hereinafter, control apparatuses according to the first and second embodiments will be described with reference to the drawings. In the following description, constituent elements having substantially the same function and configuration are denoted by the same reference numeral, and repetitive descriptions will be given only where necessary.

In the present embodiment, terms are defined as follows.

Holding pattern; This is a parameter set for the robot to execute the operation of taking out a workpiece. The holding pattern typically includes a position (holding position) for holding the workpiece with the hand (end effector) of the robot and a posture (holding posture) for holding the workpiece. Of course, the holding pattern may represent only one of the holding position and the holding posture. Usually, in bulk picking, a plurality of holding patterns are prepared. A control apparatus selects one holding pattern from a plurality of holding patterns for one workpiece to be taken out, and controls the robot based on the selected holding pattern. Thus, the workpiece to be taken out can be taken out from the container or the like.

Holding pattern candidate: A parameter that is a candidate to be registered as a holding pattern for the robot or the control apparatus that controls the robot. The holding pattern candidate is created based on an existing holding pattern.

In the present embodiment, “holding” is a concept including suction, grasping, and the like. That is, when a hand having a function of grasping a workpiece is used, the holding pattern (holding position, holding posture) may be rephrased as a grasping pattern (grasping position, grasping posture). Similarly, when a hand having a function of sucking a workpiece is used, the holding pattern (holding position, holding posture) may be rephrased as a suction pattern (suction position, suction posture).

The control apparatus of the present disclosure is a computer apparatus having a function of creating holding pattern candidates based on a plurality of holding patterns registered in advance, a function of receiving a user instruction for additionally registering, as a holding pattern, at least one holding pattern candidate of the created holding pattern candidates, and a function of storing at least one received designated holding pattern candidate as a holding pattern.

### First Embodiment

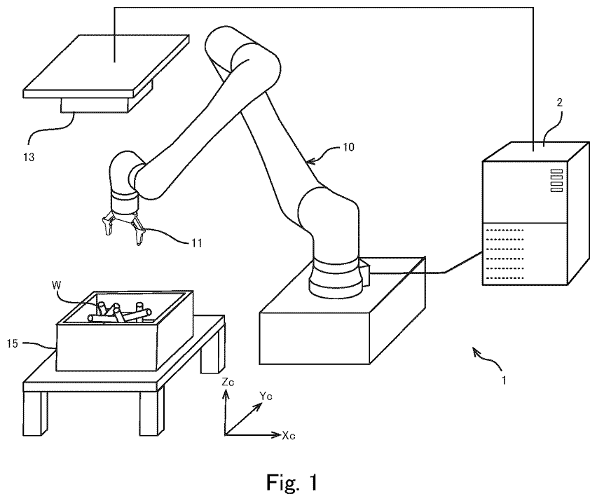

As shown in FIG. 1, a robot system 1 including a control apparatus 2 according to the first embodiment includes a robot 10 equipped with a robot hand 11 as an end effector for taking out a bulk workpiece W in a container 15, a three-dimensional vision camera 13 arranged at a position where an opening of the container 15 storing the workpieces W is viewed from above for imaging the container 15, and a control apparatus 2 for controlling the robot 10 and the three-dimensional vision camera 13. The three-dimensional vision camera 13 generates imaging data relating to the workpiece W stored in the container 15. The imaging data is also referred to as point cloud data.

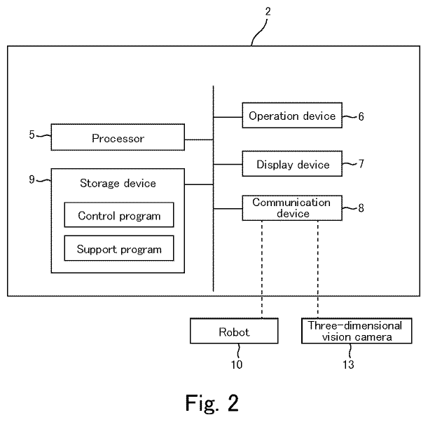

As shown in FIG. 2, the control apparatus 2 is configured by connecting hardware such as an operation device 6, a display device 7, a communication device 8, and a storage device 9 to a processor 5 such as a CPU.

The operation device 6 is implemented by a keyboard, a mouse, a jog, or the like. The operation device 6 may be implemented by a touch panel that also serves as the display device 7, or may be implemented by a dedicated pendant of the robot 10. The user can input various types of information to the control apparatus 2 through the operation device 6. The display device 7 is implemented by an LCD or the like, and displays various screens under the control of the processor 5. The communication device 8 is implemented by a communication module conforming to any communication standard, and transmits and receives various types of data to and from the robot 10 and the three-dimensional vision camera 13 under the control of the processor 5. The storage device 9 is implemented by an HDD, an SSD, or the like. The storage device 9 stores therein a control program and a support program. The support program may be configured as a part of the control program, or may be executed in conjunction with the control program.

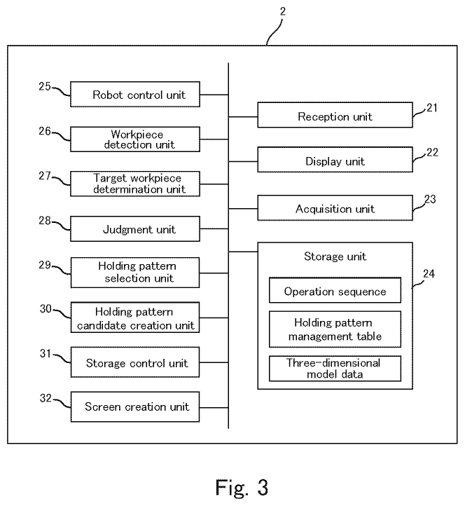

As shown in FIG. 3, when the control program stored in the storage device 9 is executed by the processor 5 together with the support program, the control apparatus 2 functions as a reception unit 21, a display unit 22, an acquisition unit 23, a storage unit 24, a robot control unit 25, a workpiece detection unit 26, a target workpiece determination unit 27, a judgment unit 28, a holding pattern selection unit 29, a holding pattern candidate creation unit 30, a storage control unit 31, and a screen creation unit 32.

The reception unit 21 receives a user operation through the operation device 6. The reception unit 21 is implemented by the function of the operation device 6 shown in FIG. 2. Specifically, the reception unit 21 receives user operations on a reception screen displayed on the display device 7. The user operations on the reception screen include an operation of clicking a create button, an operation of clicking an execute button, an operation of clicking an add button, an operation of selecting at least one holding pattern candidate to be stored in the storage unit 24 as a holding pattern from a plurality of holding pattern candidates, an operation of inputting a priority of at least one holding pattern candidate to be stored in the storage unit 24, and the like. The display unit 22 displays the reception screen created by the screen creation unit 32. The display unit 22 is implemented by the function of the display device 7 shown in FIG. 2. The acquisition unit 23 acquires imaging data of the container 15 from the three-dimensional vision camera 13. The acquisition unit 23 is implemented by the function of the communication device 8 shown in FIG. 2.

The storage unit 24 stores various types of data necessary for the robot 10 to execute bulk picking. The storage unit 24 is implemented by the function of the storage device 9 shown in FIG. 2. Various types of data required for operation control of the robot 10 include an operation sequence, setting data, and a holding pattern management table. The operation sequence describes a procedure for causing the robot 10 to execute bulk picking. The setting data includes an operation speed, an operation format, an interpolation format, and the like of the robot 10. The holding pattern management table stores holding patterns of the robot hand 11 for the workpiece W in a table format. Details of the holding pattern management table will be described later. Note that the holding patterns of the robot hand 11 for the workpiece W may be stored in the storage unit 24 in other formats instead of in the table format.

The storage unit 24 stores various types of data necessary for support processing for supporting a user's operation of adding a holding pattern. The various types of data necessary for the support processing include various types of data necessary for screen creation by the screen creation unit 32 and data necessary for a judgment process by the judgment unit 28. Various types of data necessary for the screen creation include a screen format, text data, image data, a basic model of a schematic diagram, and the like. The data necessary for the judgment process includes data necessary for executing a simulation for holding the workpiece W stored in the container 15 with the robot hand 11, such as data of a three-dimensional model of the robot 10 including the robot hand 11, data of a three-dimensional model of the workpiece W, and data of a three-dimensional model of the container 15.

The robot control unit 25 controls the robot 10 and the three-dimensional vision camera 13 in accordance with an operation sequence in order to cause the robot 10 to execute an operation of taking out bulk workpieces W piled up in the container 15. In the procedure for holding the target workpiece W, the robot control unit 25 controls the robot 10 based on the holding pattern selected by the holding pattern selection unit 29 to be described later.

The workpiece detection unit 26 detects the workpiece W in the container 15 based on the imaging data acquired from the three-dimensional vision camera 13. For example, known image processing methods such as template matching using template data registered in advance, three-dimensional matching using shape data of the three-dimensional model of the workpiece W stored in the storage unit 24, and pixel threshold processing on an extracted inner area of the container 15 can be employed for the detection of the workpiece W.

The target workpiece determination unit 27 determines a workpiece W to be held (referred to as a target workpiece W) based on the imaging data acquired from the three-dimensional vision camera 13. For example, the target workpiece determination unit 27 randomly determines the target workpiece W from the workpieces W whose entirety is detected in the imaging data, in other words, the workpieces W whose entirety is exposed to the opening side of the container 15.

The judgment unit 28 judges the holding possibility of the target workpiece W with the holding pattern (holding pattern candidate) based on the imaging data acquired from the three-dimensional vision camera 13. Specifically, the judgment unit 28 calculates the position and orientation of the target workpiece W and the positions and orientations of the other workpieces W in the container 15 based on the imaging data. Then, the judgment unit 28 calculates the holding position and the holding posture of the target workpiece W based on the holding pattern, and calculates the interference possibility of the robot hand 11 with the container 15 and the other workpieces W when the robot hand 11 is arranged at the holding position of the target workpiece W with the robot hand 11 in the holding posture. Then, the judgment unit 28 calculates the holding possibility based on the interference possibility.

For example, the interference possibility of the robot hand 11 with the container 15 and the other workpieces W is calculated as follows. That is, when the area corresponding to the robot hand 11 overlaps with the area corresponding to the container 15 or other workpieces W, the interference possibility is calculated as 100%, and when the area corresponding to the robot hand 11 does not overlap with the area corresponding to the container 15 or other workpieces W and the areas are separated from each other by a predetermined distance, the interference possibility is calculated as 0%. When the area corresponding to the robot hand 11 does not overlap with the area corresponding to the container 15 or other workpieces W but the areas are closer to each other than a predetermined distance, the interference possibility is calculated according to the distance therebetween.

The judgment unit 28 calculates the holding possibility by subtracting the interference possibility from 100%. That is, 100% interference possibility can be expressed as 0% holding possibility, and 0% interference possibility can be expressed as 100% holding possibility. The judgment unit 28 judges whether or not the target workpiece W can be held with each holding pattern by comparing the holding possibility with a preset threshold value.

The holding pattern selection unit 29 selects one holding pattern to be used to hold the target workpiece W from a plurality of holding patterns. Specifically, the holding pattern selection unit 29 selects a holding pattern judged by the judgment unit 28 to have a high holding possibility of the target workpiece W from a plurality of holding patterns. In the case where the priority is set for each holding pattern, the holding pattern selection process is verified in order of priority, starting with the highest priority holding pattern.

The holding pattern candidate creation unit 30 creates a holding pattern candidate based on the existing holding pattern. Details of the process of creating a holding pattern candidate will be described later.

The storage control unit 31 causes the storage unit 24 to store the holding pattern candidate selected by a user operation as a holding pattern. Thereby, the received holding pattern candidate is added to the existing holding patterns.

The screen creation unit 32 creates a reception screen in accordance with a predetermined format. Details of the reception screen will be described later.

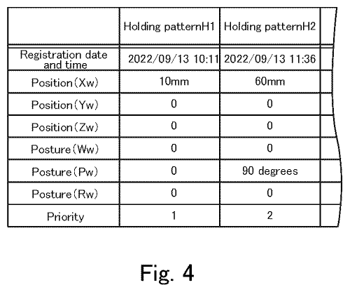

The holding pattern management table will be described below with reference to FIG. 4. FIG. 4 shows an example of the holding pattern management table. As shown in FIG. 4, in the holding pattern management table, each of the plurality of holding patterns is managed together with registration date and time information and priority. The holding pattern includes a parameter relating to a holding position and a parameter relating to a holding posture. Typically, the parameter relating to a holding position and the parameter relating to a holding posture are expressed in a workpiece coordinate system. The workpiece coordinate system is a coordinate system defined by the target workpiece W.

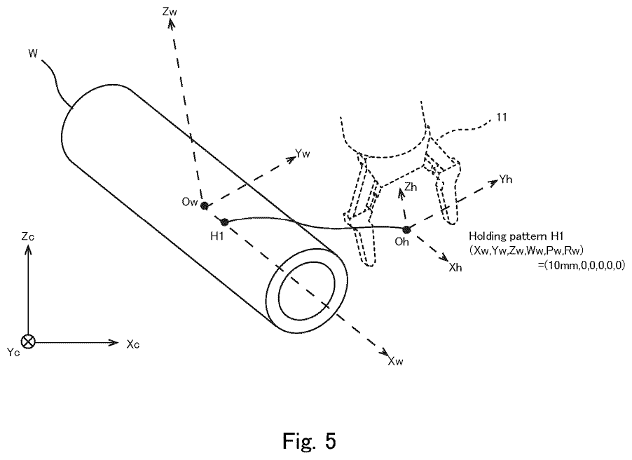

Hereinafter, the holding pattern will be described with reference to FIG. 5. Here, a holding pattern H1 managed by the holding pattern management table of FIG. 4 will be described as an example. As shown in FIG. 5, the workpiece W is assumed to be a cylindrical body. A workpiece coordinate system defined by the workpiece W and a hand coordinate system defined by the robot hand 11 are defined as follows. That is, the center position of the cylindrical body is defined as the origin Ow of the workpiece coordinate system, an axis parallel to the center line of the cylindrical body is defined as the Xw axis, and two axes orthogonal to the Xw axis and also orthogonal to each other are defined as the Yw axis and the Zw axis, respectively. Further, the grasping center position of the pair of fingers is defined as the origin Oh of the hand coordinate system, the axis along the opening/closing direction of the pair of fingers is defined as the Yh axis, the axis along the center line of the robot hand 11 is defined as the Zh axis, and the axis orthogonal to the Yh axis and the Zh axis is defined as the Xh axis.

When the workpiece coordinate system and the hand coordinate system are defined as described above, as shown in FIG. 5, the holding pattern H1 ((Xw, Yw, Zw, Ww, Pw, Rw)=(10 mm, 0, 0, 0, 0, 0)) means that the workpiece W is held in a posture in which the robot hand 11 is not inclined with respect to the workpiece W at a position shifted by 10 mm along the central axis (Xw axis) from the center position (Ow) of the workpiece W.

In cases where the axes of the workpiece coordinate system cannot be defined only by the features of the workpiece W, such as a workpiece W having a line-symmetric or point-symmetric shape such as a cylindrical, sphere, or quadrangular body, at least one of the three axes defining the workpiece coordinate system may be defined based on another fixed coordinate system such as a container coordinate system (Xc, Yc, Zc).

Further, the holding pattern of the workpiece W may be expressed not by the workpiece coordinate system but by another coordinate system such as a container coordinate system.

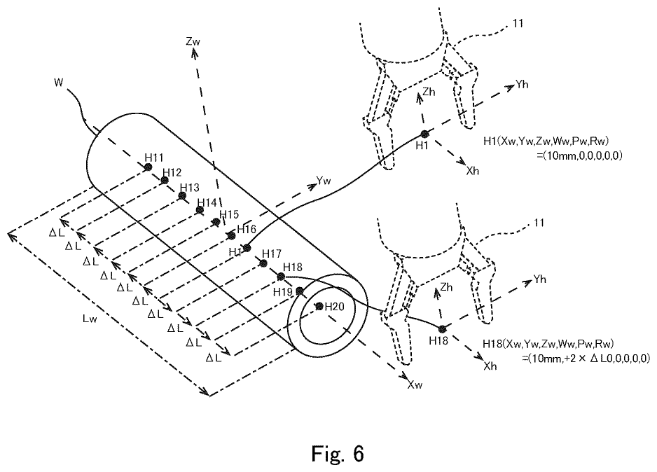

The process of creating a holding pattern candidate by the holding pattern candidate creation unit 30 will be described below with reference to FIG. 6. Typically, the holding pattern candidate creation unit 30 creates a holding pattern candidate based on the holding pattern, the three-dimensional model of the container 15, the three-dimensional model of the target workpiece W, and the three-dimensional model of the robot hand 11. Specifically, the holding pattern candidate creation unit 30 extracts a plurality of holding pattern candidates by searching a predetermined range from the holding pattern, and creates at least one holding pattern candidate from the plurality of extracted holding pattern candidates. The predetermined range may be set in accordance with a user designation received through the reception unit 21, or may be automatically set in accordance with the target workpiece W. As shown in FIG. 6, for example, when the length of the target workpiece W is Lw, the predetermined range to be searched for holding pattern candidates has a maximum range in which the holding position Xw is less than ±Lw/2. The narrower the search range, the faster the calculation processing.

An example of creating a holding pattern candidate based on the holding pattern H1 managed in the holding pattern management table of FIG. 4 will be described below. As shown in FIG. 6, the holding pattern candidate creation unit 30 searches the range of the length Lw from the target workpiece W, extracts a plurality of holding pattern candidates (H11, H12, . . . , H20) by shifting the holding pattern H1 by a unit length ΔL along the Xw-axis direction, and extracts and creates, from the plurality of extracted holding pattern candidates (H11, H12, . . . , H20), one holding pattern candidate (H18) that is capable of holding the target workpiece W (that is, does not interfere with the surrounding objects) and is closest to the existing holding pattern H1. Note that whether or not the target workpiece W can be held with the holding pattern candidate, in other words, whether or not the robot hand 11 that operates with the holding pattern candidate interferes with the surrounding objects, can be judged by a simulation using the three-dimensional model of the container 15, the three-dimensional model of the target workpiece W, and the three-dimensional model of the robot hand 11, as in the process of the judgment unit 28.

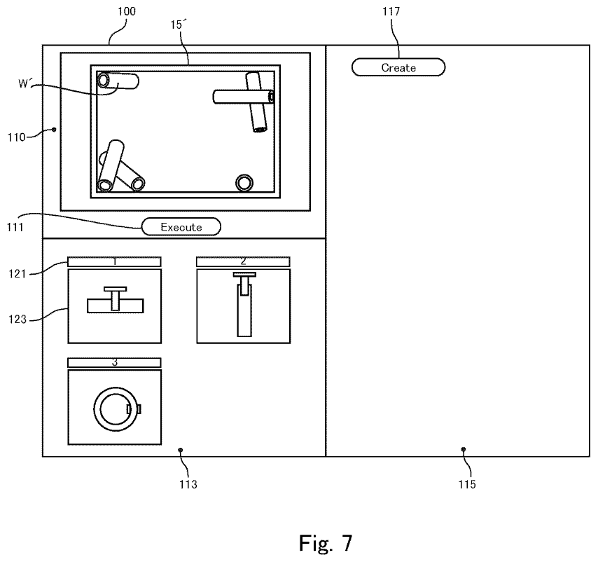

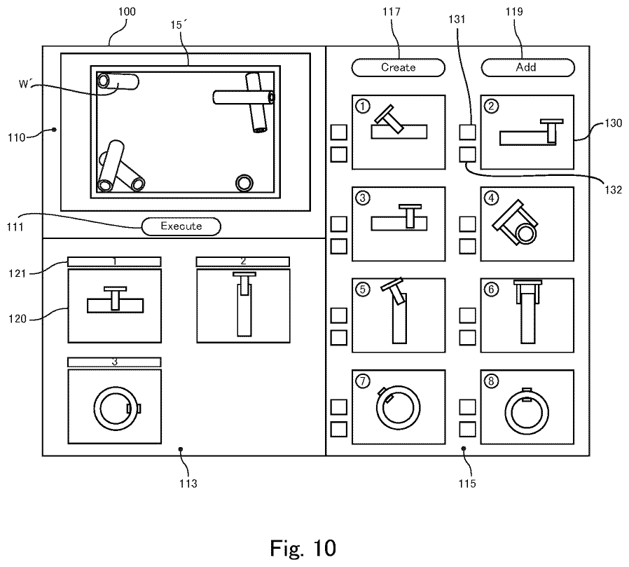

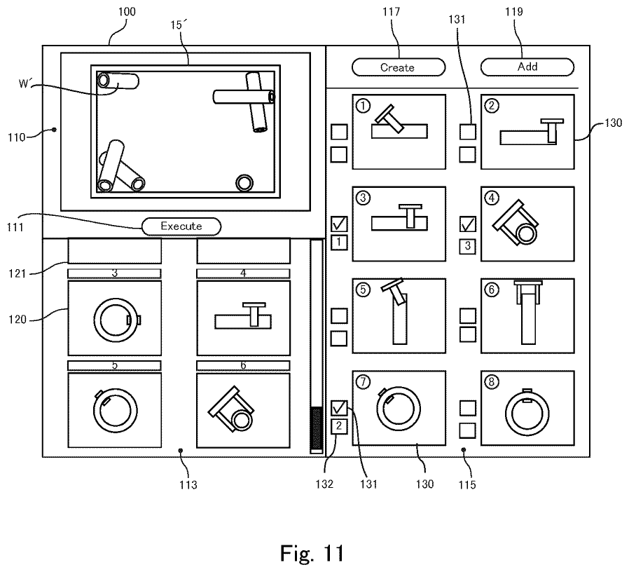

The reception screen will be described below with reference to FIG. 7. FIG. 7 shows an example of the reception screen displayed on the display device 7. As shown in FIG. 7, the reception screen 100 has a first area 110, a second area 113, and a third area 115. In the first area 110, imaging data relating to the container 15′ and an execute button 111 are displayed. In the second area 113, the holding pattern stored in the storage unit 24 is displayed together with the priority 121. For example, the holding pattern is expressed as a schematic diagram of the workpiece W and the robot hand 11 so that the holding position and the holding posture with respect to the workpiece W can be seen. A create button 117 is displayed in the third area 115. Although not shown in FIG. 7, a plurality of schematic diagrams each representing a plurality of holding pattern candidates are displayed in the third area (see FIG. 10 and FIG. 11).

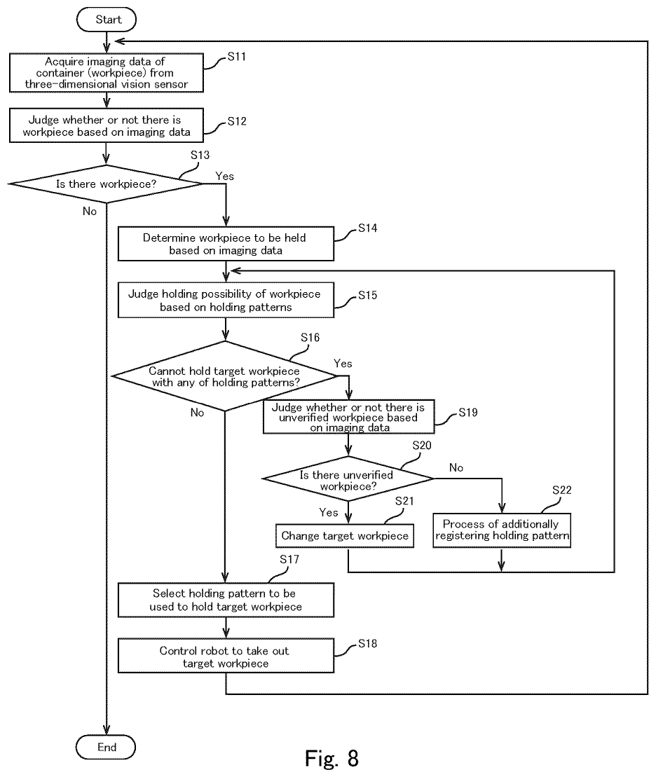

The bulk picking operation by the robot 10 will be described below with reference to FIG. 8. FIG. 8 is a flowchart showing an example of a control procedure of the robot 10 by the control apparatus 2 when the robot 10 is caused to perform bulk picking.

As shown in FIG. 8, when the control program is executed, the control apparatus 2 controls the three-dimensional vision camera 13 to acquire, from the three-dimensional vision camera 13, imaging data relating to the workpiece W stored in the container 15 (S11), and judges whether or not there is a workpiece W inside the container 15 based on the acquired imaging data (S12). When there is a workpiece W inside the container 15 (S13; Yes), the control apparatus 2 determines a target workpiece W to be held based on the imaging data (S14), and judges the holding possibility of the determined target workpiece W based on a plurality of holding patterns (S15). The judgment of the holding probability of the target workpiece W with the plurality of holding patterns is performed in order according to the priority of the holding patterns. By prioritizing the holding patterns, the process of step S15 is terminated when a holding pattern having a high holding possibility of the target workpiece W is found; thus, increasing the priority of frequently used holding patterns can suppress the increase in processing speed for step S15.

When the holding possibility of the target workpiece W is equal to or greater than a predetermined value, that is, when the target workpiece W can be held with any one of the plurality of holding patterns (S16; No), the control apparatus 2 selects a holding pattern that is capable of holding the target workpiece W from the plurality of holding patterns (S17), and controls the robot 10 in accordance with the selected holding pattern (S18). As a result of the process of step S18, the target workpiece W is taken out from the container 15. On the other hand, when the holding possibility of the target workpiece W is less than the predetermined value, that is, when the target workpiece W cannot be held with any of the plurality of holding patterns (S16; Yes), the control apparatus 2 determines whether or not there is another unverified workpiece W based on the imaging data (S19). Here, another unverified workpiece W is a workpiece W for which the judgment process of step S15 has not been performed.

When there is another unverified workpiece W, that is, when there is still a possibility that the workpiece W remaining in the container 15 can be held with the existing holding patterns (S20; Yes), the control apparatus 2 changes the target workpiece W to the unverified workpiece W (S21), and returns the processing to step S15. On the other hand, when there is no other unverified workpiece W, that is, when the workpiece W remaining in the container 15 cannot be held with the existing holding pattern (S20; No), the control apparatus 2 executes a process of additionally registering a new holding pattern (S22), and returns the processing to step S15.

The series of processes from step S11 to step S22 is repeatedly executed until all of the workpieces W stored in the container 15 are taken out and there are no more workpieces W inside the container 15. Based on the fact that there are no more workpieces W inside the container 15, the control of the robot 10 by the control apparatus 2 is ended, and the bulk picking by the robot 10 is completed (S13; No).

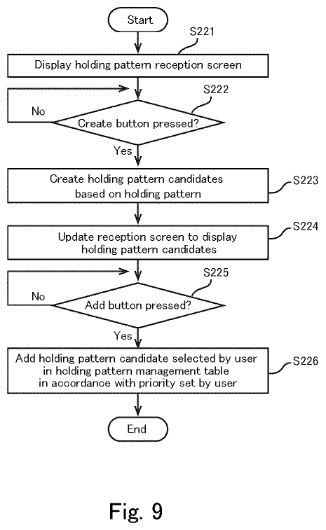

The user support processing by the control apparatus 2 according to the first embodiment will be described below with reference to FIG. 7, FIG. 9, FIG. 10, and FIG. 11. FIG. 9 is a flowchart showing an example of the procedure of step S22 in FIG. 8. FIG. 10 shows the reception screen updated based on clicking of the create button. FIG. 11 shows the reception screen updated based on clicking of the add button.

As shown in FIG. 9, when the workpiece W remaining in the container 15 cannot be held with the existing holding patterns, the control apparatus 2 displays the reception screen (S221). By the process of step S221, the reception screen 100 as shown in FIG. 7 is displayed on the display device 7. Then, the control apparatus 2 waits for the creation process of the next step until the create button 117 displayed on the reception screen 100 is clicked (S222; No).

Based on clicking of the create button 117 (S222; Yes), the control apparatus 2 creates holding pattern candidates based on the holding pattern (S223). Then, the control apparatus 2 creates the reception screen 100 in which schematic diagrams corresponding to the holding pattern candidates are inserted in accordance with a predetermined format, and updates the reception screen 100 displayed on the display device 7 (S224). By the process of step S224, the reception screen 100 shown in FIG. 7 is updated to the reception screen 100 shown in FIG. 10. As shown in FIG. 10, in the third area 115 of the updated reception screen 100, a plurality of schematic diagrams 130 respectively representing a plurality of holding pattern candidates created in step S223 are displayed. Each schematic diagram 130 is displayed with a check box 131 and a priority input field 132 in association with each other. Then, the control apparatus 2 waits for the additional registration process of the next step until the add button 119 displayed on the reception screen 100 is clicked (S225; No). The user can select a holding pattern candidate to be additionally registered as a holding pattern by clicking the check box 131 displayed on the reception screen 100. Further, the priority can be set by an input operation to the input field 132.

Based on clicking of the add button 119 (S225; Yes), at least one holding pattern candidate selected by the user from the plurality of retention pattern candidates displayed on the reception screen 100 is additionally registered in the holding pattern management table in accordance with the priority set by the user (S226). By the process of step S226, the reception screen 100 shown in FIG. 10 is updated to the reception screen 100 shown in FIG. 11. As shown in FIG. 11, a schematic diagram 120 corresponding to the holding pattern candidate displayed in the third area 115 and selected by the user is added to the second area 113 of the updated reception screen 100.

The priority set by the user may be defined as the priority among the holding pattern candidates to be additionally registered, or may be defined as the priority among all including the existing holding patterns. The definition of the priority can be switched in accordance with a user instruction. Further, the priority of the existing holding patterns can be changed at any timing in accordance with a user instruction. For example, in the case where the priority is defined as the priority among the holding pattern candidates to be additionally registered, a priority lower than the priority assigned to the existing holding patterns is assigned to the holding pattern candidate to be additionally registered, in accordance with the priority set by the user.

The control apparatus 2 according to the first embodiment has the following advantageous effects. That is, the control apparatus 2 according to the first embodiment can present the reception screen 100 including the holding pattern candidate to be additionally registered as a holding pattern to the user. The user does not need to teach a holding pattern by an operation of directly inputting coordinates or an operation on a simulation screen, but only needs to confirm presented holding pattern candidates, select a holding pattern candidate to be additionally registered as a holding pattern, and click the add button 119 in order to additionally register (teach) the selected holding pattern candidate as a holding pattern. Therefore, even a user who is not familiar with the setting of bulk picking can easily perform the operation of adding (teaching) a holding pattern of the workpiece W.

The above-described additional registration of a holding pattern can be performed when the workpiece W remaining in the container 15 cannot be held with the existing holding patterns. Therefore, the new holding pattern added by the additional registration of a holding pattern is only a pattern that is capable of holding the target workpiece W that cannot be held with the existing holding patterns. As described above, since only the holding patterns that is capable of holding the workpiece W that cannot be held with the existing holding patterns can be cumulatively added, it is possible to prevent the situation in which the number of holding patterns increases unnecessarily, and it is possible to gradually reduce the time in which the robot 10 stops because the workpiece W cannot be held.

In addition, the holding pattern candidates presented to the user have a high possibility that the target workpiece W can be held without interference with the surrounding objects by simulation. However, even if a holding pattern candidate is judged to be capable of holding the target workpiece W by simulation, there is a possibility that the target workpiece W cannot be held due to the influence of the state of the robot 10 or the workpiece W, or the surrounding environment. In the first embodiment, it is possible to add only the holding pattern candidate finally confirmed by the user, instead of automatically adding the created holding pattern candidates as holding patterns. Thus, it is possible to add only a holding pattern candidate having a high possibility of holding the workpiece W that cannot be held with the existing holding patterns. This contributes to suitably preventing a situation in which the number of holding patterns increases unnecessarily.

In the first embodiment, the holding pattern candidate creation unit 30 creates holding pattern candidates based on a holding pattern, the three-dimensional model of the container 15, the three-dimensional model of the target workpiece W, and the three-dimensional model of the robot hand 11. This makes it possible to narrow down the holding pattern candidates that are capable of holding the target workpiece W and present them to the user, so that no matter which holding pattern candidate the user selects, a holding pattern that has a high holding possibility of the target workpiece W can be additionally registered. However, since the user finally determines whether or not the target workpiece W can be held, the holding pattern candidates may be presented to the user regardless of whether or not they are capable of holding the target workpiece W at the stage of presenting the holding pattern candidates to the user.

Therefore, the holding pattern candidate creation unit 30 may create holding pattern candidates based on only a holding pattern or based on a holding pattern and the three-dimensional model of the target workpiece W. Specifically, the holding pattern candidate creation unit 30 can create holding pattern candidates by adding or subtracting a predetermined offset amount to or from a holding pattern. In addition, the holding pattern candidate creation unit 30 can extract a plurality of holding pattern candidates by searching a predetermined range from the holding pattern H1, and create at least one holding pattern candidate closest to the center of gravity of the target workpiece W from the extracted plurality of holding pattern candidates.

In the first embodiment, when the workpiece W remaining in the container 15 cannot be held with the existing holding patterns, the reception screen is displayed (S221). However, the reception screen can be displayed at any timing, and for example, the reception screen may be displayed all the time after the start of bulk picking.

In the first embodiment, based on clicking of the create button displayed on the reception screen, i.e., in response to a user operation, the process of creating holding pattern candidates is executed. However, it may be automatically performed at a timing when it is determined that the workpiece W remaining in the container 15 cannot be held with the existing holding patterns.

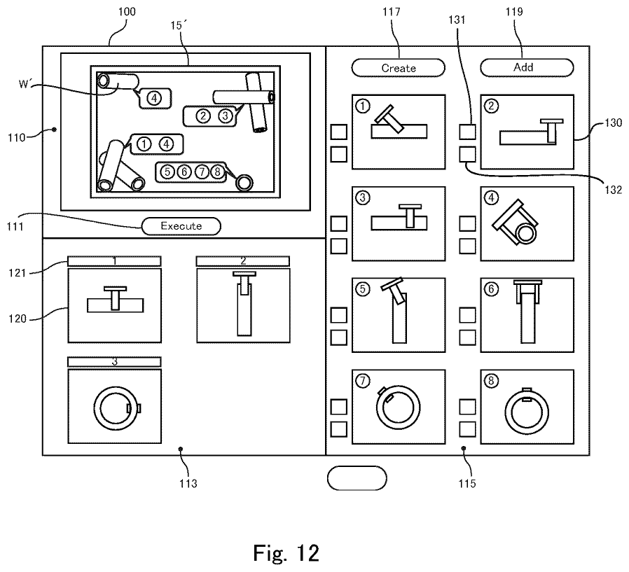

In the reception screen 100 shown in FIG. 10, the user has to judge which workpiece W′ each of the plurality of holding pattern candidates is presented as being capable of holding. Therefore, as shown in FIG. 12, for example, a balloon shows the correspondence relationship between the workpiece W′ and the holding pattern candidate so that it can be understood which workpiece W′ each of the plurality of holding pattern candidates is presented as being capable of holding. As a result, it is possible to further reduce the time and effort for the user to add the holding pattern candidate. The method for showing the correspondence relationship between the workpiece W′ and the holding pattern candidate capable of holding the workpiece W′ is not limited to the balloon, and for example, an existing identification method such as color or hatching can be employed.

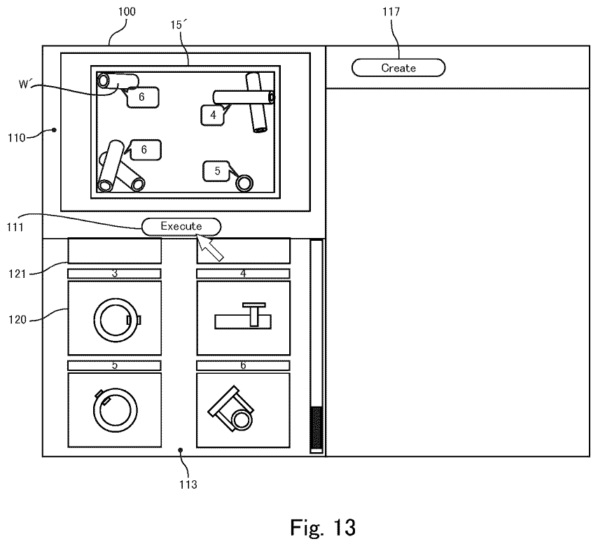

An execute button 111 is provided on the reception screen 100 so that it can be confirmed by a simulation whether the workpiece W′ remaining in the container 15 can be held with the newly added or existing holding patterns. When the execute button 111 is clicked, a simulation is executed based on the imaging data, and information relating to whether or not the workpiece W′ remaining inside the container 15 can be held with a plurality of holding patterns including the newly added holding pattern candidate is displayed. For example, as shown in FIG. 13, when the execute button 111 is clicked, the correspondence relationship between the workpiece W′ and the holding pattern is shown by a balloon so that it can be understood with which holding pattern the workpiece W′ remaining inside the container 15 can be held. This allows the user to confirm again whether the workpiece W′ remaining in the container 15′ can be held with the newly added holding pattern. If the added holding pattern is a holding pattern with which no target workpiece W′ can be held, the newly added holding pattern may be deleted because the holding pattern is unnecessary. This makes it possible to avoid a situation in which the number of holding patterns increases unnecessarily. The method for showing the correspondence relationship between the workpiece W′ and the holding pattern that is capable of holding the workpiece W′ is not limited to the balloon, and for example, an existing identification method such as color or hatching can be employed.

### Second Embodiment

A control apparatus 2′ according to a second embodiment is an apparatus obtained by adding a function of adjusting a holding pattern candidate to the control apparatus 2 according to the first embodiment. Since the hardware configuration of the control apparatus 2′ according to the second embodiment is the same as that of the control apparatus 2 according to the first embodiment, the description thereof will be omitted (see FIG. 2).

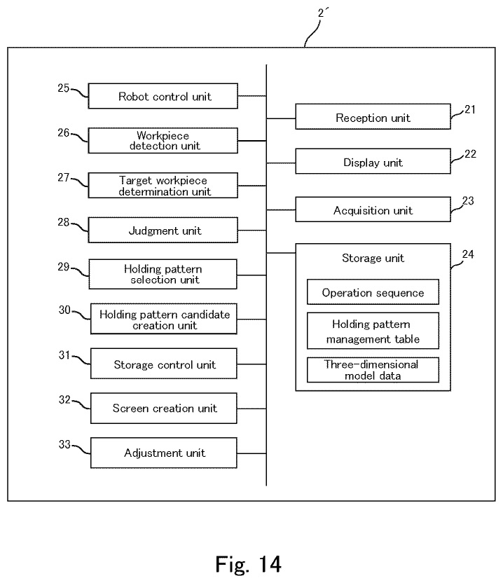

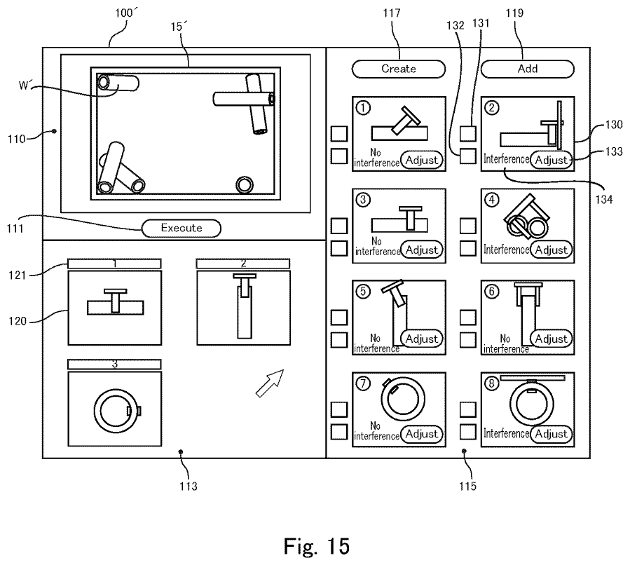

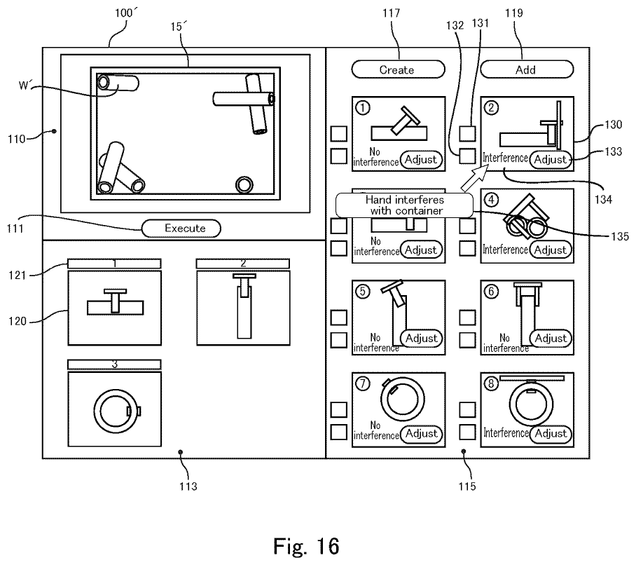

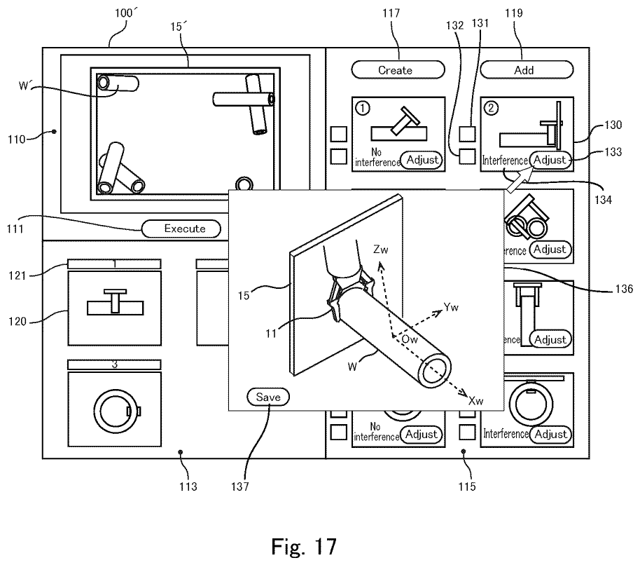

The control apparatus 2′ according to the second embodiment will be described below with reference to FIG. 14, FIG. 15, FIG. 16 and FIG. 17. FIG. 14 is a functional block diagram of the control apparatus 2′ according to the second embodiment. As shown in FIG. 14, the control apparatus 2′ according to the second embodiment is configured by adding an adjustment unit to the control apparatus 2 according to the first embodiment (see FIG. 3).

The reception unit 21 receives, as a user operation on the reception screen, a user instruction relating to adjustment of the plurality of holding pattern candidates. The adjustment unit 33 adjusts the holding pattern candidates in accordance with an adjustment instruction from the user received by the reception unit 21.

FIG. 15 shows an example of a reception screen presented to the user by the control apparatus 2′ according to the second embodiment. FIG. 16 shows the reception screen when a cursor is positioned on interference information in FIG. 15. FIG. 17 shows the reception screen when an adjust button is clicked in FIG. 15. FIG. 15 corresponds to FIG. 10 of the first embodiment.

As shown in FIG. 15, in a reception screen 100′ presented to the user by the control apparatus 2′ according to the second embodiment, a check box 131, a priority input field 132, an adjust button 133, and interference information 134 are displayed in association with each other in a schematic diagram 130. The interference information 134 is information relating to interference between the surrounding objects around the target workpiece W and the robot hand 11. For example, as shown in FIG. 15, when the robot hand 11 interferes with the surrounding objects, “INTERFERENCE” is displayed as the interference information 134, and when the robot hand 11 does not interfere with the surrounding objects, “NO INTERFERENCE” is displayed as the interference information 134. When there is no interference, the interference information 134 may be hidden. Note that the surrounding objects include the container 15 and the workpieces W other than the target workpiece W.

In FIG. 15, when the cursor is positioned at the interference information 134, a detail screen 135 describing the details of the interference information pops up as shown in FIG. 16. Note that the details of the interference information may be displayed on the reception screen 100′ in place of the interference information 134 “INTERFERENCE”.

In FIG. 15, when the adjust button 133 is clicked, as shown in FIG. 17, an adjustment screen 136 for receiving an adjustment of a holding pattern candidate pops up. The adjustment screen 136 includes a virtual space in which the three-dimensional model of the workpiece W, the three-dimensional model of the container 15, and the three-dimensional model of the robot hand 11 are arranged based on the holding pattern candidate. The user can adjust the holding pattern candidate by inputting a moving operation and a rotating operation for the three-dimensional model of the robot hand 11, and can overwrite the holding pattern candidate with the adjusted holding pattern candidate by clicking a save button 137. The user can additionally register the adjusted holding pattern candidate as a holding pattern. As long as the holding pattern candidate can be adjusted, the adjustment method is not limited to this. For example, the coordinates of the holding position and the coordinates of the holding posture corresponding to the holding pattern candidate may be displayed so that these coordinates can be adjusted.

The control apparatus 2′ according to the second embodiment has the following advantageous effects. That is, the control apparatus 2 according to the first embodiment can present to the user only holding pattern candidates that do not interfere with the surrounding objects. Thus, the user can easily additionally register a holding pattern capable of holding the target workpiece W without causing the robot hand 11 to interfere with the surrounding objects only by selecting a presented holding pattern candidate.

On the other hand, when the surrounding objects are arranged in a complex manner with respect to the target workpiece W, there is a possibility that a holding pattern candidate capable of holding the target workpiece W cannot be automatically generated. The control apparatus 2′ according to the second embodiment can display not only the holding pattern candidates that do not interfere with the surrounding objects but also the holding pattern candidates that interfere with the surrounding objects as holding pattern candidates to be selected, and can adjust a holding pattern candidate in accordance with a user instruction. As a result, it is possible to suitably avoid the above-described situation that a holding pattern candidate that is capable of holding the target workpiece W cannot be automatically generated.

The various types of data stored in the storage device 9 may be distributed by being recorded on removable media, or may be distributed by being downloaded to the control apparatus 2′ via the network W.

The following appendixes are further disclosed with respect to the present embodiments and modifications.

### Appendix 1

A control apparatus 2 for controlling a robot to execute an operation of taking out a bulk workpiece W comprises: a storage unit 24 for storing data relating to a plurality of holding patterns for holding the workpiece W, a selection unit 29 for selecting one holding pattern of the plurality of holding patterns for the workpiece, a control unit 25 for controlling a robot based on the selected one holding pattern, a creation unit 30 for creating a plurality of holding pattern candidates based on the holding pattern, a reception unit 21 for receiving a user instruction for adding at least one of the created holding pattern candidates as the holding pattern, and a storage control unit 31 for causing the storage unit 24 to store the received holding pattern candidate as the holding pattern.

### Appendix 2

The creation unit 30 described in Appendix 1 creates the plurality of holding pattern candidates in response to a user instruction.

### Appendix 3

The control apparatus 2 described in Appendix 1 further comprises an acquisition unit 23 for acquiring imaging data of the workpiece W, and a judgment unit 28 for judging, based on the imaging data, a holding possibility of the workpiece W with the holding pattern added to the storage unit 24.

### Appendix 4

The creation unit 30 of Appendix 3 creates the plurality of holding pattern candidates when the holding possibility is lower than a predetermined value for any of the plurality of holding patterns.

### Appendix 5

In the control apparatus 2 of Appendix 1, the storage unit 24 further stores data of a three-dimensional model of the workpiece W, and the creation unit 30 creates the plurality of holding pattern candidates based on the holding pattern and the data of the three-dimensional model of the workpiece W.

### Appendix 6

The storage unit 24 of Appendix 5 further stores data of a three-dimensional model of a hand for holding the workpiece W, and the creation unit 30 creates the plurality of holding pattern candidates based on the holding pattern, the data of the three-dimensional model of the workpiece W, and the data of the three-dimensional model of the hand.

### Appendix 7

In the control apparatus 2 of Appendix 1, the holding pattern includes at least a holding position for holding the workpiece W, and the creation unit 30 creates the holding pattern candidates within a predetermined range from the holding position of the holding pattern.

### Appendix 8

The reception unit 21 of Appendix 7 receives a user designation of the predetermined range.

### Appendix 9

The control apparatus 2 of Appendix 1 further comprises an acquisition unit 23 for acquiring imaging data of the workpiece W, and a judgment unit 28 for judging an interference possibility with a surrounding object around the workpiece W based on the imaging data for each of the plurality of holding pattern candidates.

### Appendix 10

The control apparatus 2 of Appendix 9 further comprises a display unit 22 for displaying a reception screen for receiving a user instruction to add at least one of the created holding pattern candidates as the holding pattern, and only a holding pattern candidate whose interference possibility with the surrounding object is judged to be lower than a predetermined value is displayed on the reception screen.

### Appendix 11

The control apparatus 2 of Appendix 9 further comprises a display unit 22 for displaying a reception screen for receiving a user instruction to add at least one of the created holding pattern candidates as the holding pattern, and among the holding pattern candidates displayed on the reception screen, a holding pattern candidate whose interference possibility with the surrounding object is judged to be equal to or higher than a predetermined value is displayed together with information relating to a surrounding object with a high interference possibility.

### Appendix 12

In the control apparatus 2 of any one of Appendixes 9 to 11, the surrounding object includes one of a container 15 storing the workpiece W or another workpiece W that is different from the workpiece W.

### Appendix 13

In the control apparatus 2 of any one of Appendixes 1 to 12, a priority is set for each of the plurality of holding patterns, the reception unit 21 receives at least one of the created holding pattern candidates together with the priority, and the storage control unit 31 adds the received holding pattern candidate to the plurality of holding patterns in accordance with the priority.

### Appendix 14

The reception unit 21 of the control apparatus 2 of any one of Appendixes 1 to 13 receives a user instruction relating to adjustment of the plurality of holding pattern candidates.

### Appendix 15

A program causes a computer capable of controlling a robot to execute an operation of taking out a bulk workpiece W and configured to store data relating to a plurality of holding patterns for holding the workpiece W to realize means for creating a plurality of holding pattern candidates based on the holding pattern, a means for receiving a user instruction for adding at least one of the created holding pattern candidates as the holding pattern, and means for storing the received holding pattern candidate as the holding pattern.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A control apparatus for controlling a robot to execute an operation of taking out a bulk workpiece, the control apparatus comprising:
a storage unit for storing data relating to a plurality of holding patterns for holding the workpiece with an end effector of the robot;
a selection unit for selecting one holding pattern of the plurality of holding patterns for the workpiece;
a control unit for controlling the robot based on the one holding pattern;
a creation unit for creating a plurality of holding pattern candidates based on the holding pattern;
a reception unit for receiving a user instruction for adding at least one of the created holding pattern candidates as the holding pattern; and
a storage control unit for causing the storage unit to store the received holding pattern candidate as the holding pattern.

2. The control apparatus according to claim 1, wherein the creation unit creates the plurality of holding pattern candidates in response to a user instruction.

3. The control apparatus according to claim 1, further comprising:
an acquisition unit for acquiring imaging data of the workpiece; and
a judgment unit for judging, based on the imaging data, a holding possibility of the workpiece with the holding pattern added to the storage unit.

4. The control apparatus according to claim 3, wherein the creation unit creates the plurality of holding pattern candidates when the holding possibility is lower than a predetermined value for any of the plurality of holding patterns.

5. The control apparatus according to claim 1, wherein
the storage unit further stores data of a three-dimensional model of the workpiece, and
the creation unit creates the plurality of holding pattern candidates based on the holding pattern and the data of the three-dimensional model of the workpiece.

6. The control apparatus according to claim 5, wherein
the storage unit further stores data of a three-dimensional model of a hand for holding the workpiece, and
the creation unit creates the plurality of holding pattern candidates based on the holding pattern, the data of the three-dimensional model of the workpiece, and the data of the three-dimensional model of the hand.

7. The control apparatus according to claim 1, wherein
the holding pattern includes at least a holding position for holding the workpiece, and
the creation unit creates the holding pattern candidates within a predetermined range from the holding position of the holding pattern.

8. The control apparatus according to claim 7, wherein the reception unit receives a user designation of the predetermined range.

9. The control apparatus according to claim 1, further comprising:
an acquisition unit for acquiring imaging data of the workpiece; and
a judgment unit for judging an interference possibility with a surrounding object around the workpiece based on the imaging data for each of the plurality of holding pattern candidates.

10. The control apparatus according to claim 9, further comprising:
a display unit for displaying a reception screen for receiving a user instruction to add at least one of the created holding pattern candidates as the holding pattern, wherein
only a holding pattern candidate whose interference possibility with the surrounding object is judged to be lower than a predetermined value is displayed on the reception screen.

11. The control apparatus according to claim 9, further comprising:
a display unit for displaying a reception screen for receiving a user instruction to add at least one of the created holding pattern candidates as the holding pattern, wherein
among the holding pattern candidates displayed on the reception screen, a holding pattern candidate whose interference possibility with the surrounding object is judged to be equal to or higher than a predetermined value is displayed together with information relating to a surrounding object with a high interference possibility.

12. The control apparatus according to claim 9, wherein the surrounding object includes one of a container storing the workpiece or another workpiece that is different from the workpiece.

13. The control apparatus according to claim 1, wherein
a priority is set for each of the plurality of holding patterns,
the reception unit receives at least one of the created holding pattern candidates together with the priority, and
the storage control unit adds the received holding pattern candidate to the plurality of holding patterns in accordance with the priority.

14. The control apparatus according to claim 1, wherein the reception unit receives a user instruction relating to adjustment of the plurality of holding pattern candidates.

15. A non-transitory storage medium storing a program causing a computer to implement, the computer capable of controlling a robot to execute an operation of taking out a bulk workpiece and including a storage device to store data relating to a plurality of holding patterns for holding the workpiece:
creating a plurality of holding pattern candidates based on the holding pattern;
receiving a user instruction for adding at least one of the created holding pattern candidates as the holding pattern; and
causing the storage device to store the received holding pattern candidate as the holding pattern.
